(19) United States
(12) Patent Application Publication
(10) Pub. No.: US 2005/0070192 A1
(43) Pub. Date: Mar. 31, 2005

(54) Woven/non-woven fabric and method and apparatus for making the same

(75) Inventors: Costanzo Lorenzotti, Sonico Brescia (IT); Luigi Lorenzotti, Flero (Brescia) (IT); Piero Lorenzotti, Flero (Brescia) (IT)

Correspondence Address: MCGINN & GIBB, PLLC, 8321 OLD COURTHOUSE ROAD, SUITE 200, VIENNA, VA, 22182-3817, US

(73) Assignee: Sanitars S.r.I., Flero (Brescia) (IT)

(21) Appl. No.: 10/626,710

(22) Filed: Jul. 25, 2003

(30) Foreign Application Priority Data
Jul. 31, 2002 (IT) BS/2002/A/000068

(51) Int. Cl. C23C 28/00; B32B 5/02

(52) U.S. Cl. 442/327; 442/152; 442/153; 427/421.1; 118/300

(57) ABSTRACT

A method (and apparatus) for producing a woven/non-woven fabric of natural fiber includes creating a web of fibers having a predetermined weight, spraying the web of fibers with liquid at high pressure, and removing moisture from the sprayed web of fibers.

### BACKGROUND OF THE INVENTION

1. Field of the Invention

The present invention relates to a new fabric and a method of producing a new fabric to be used in disposable products for personal hygiene and domestic use. More specifically, the present invention relates to a “woven/non-woven” fabric to be used in hygienic and domestic cleaning products.

2. Description of the Related Art

In the field of disposable products, the disposable products may be produced with materials including cellulose pulp, plastic, paper, cellulose fiber, and the like. Conventionally, a binding material is used to keep the fibers used in the products (e.g., cellulose pulp, plastic, paper, cellulose fiber, etc.) bound together. However, when these conventionally-produced products are moistened or immersed in liquid (e.g., soaked), they lose their consistency, and cannot be reused. Further, the binding agents used to hold the fibers together are pollutants which are not biodegradable.

Thus, the conventional bindings of fabrics used in disposable products cause pollution, are expensive to consumers, and cannot withstand repeated use.

Additionally, conventionally produced products often cause allergies due to the composition of the fabrics used. Such allergies grow worse when conventional fabrics are employed in the cosmetic and medical field (e.g., fabrics used for nappies or for personal care).

### SUMMARY OF THE INVENTION

In view of the foregoing and other problems, drawbacks, and disadvantages of the conventional methods and structures, an exemplary feature of the present invention is to provide a woven/non-woven fabric and a method for producing the same for use in the production of hygiene and household applications (e.g., napkins, cloths, and so forth).

It is noted that, for purposes of the present application, a “woven/non-woven fabric” is called “woven” because it looks like fabric and “non-woven” because in the production process a loom is not employed. Therefore, thread is not used as in traditional fabric processing.

Further, another exemplary feature of the present invention is to provide a woven/non-woven fabric which is reusable, tear-resistant when dry or soaked, very high in absorption capacity, produced without chemical additives, ecological and biodegradable.

Additionally, another exemplary feature of the present invention is to produce a fabric which is made of natural materials, non-allergenic, and treated with a process of bacteria killing which includes exposing the cotton to high temperatures.

In addition, an exemplary feature of the present invention is to produce a fabric by recycled fibers through a sorting and dust-removing process.

In a first exemplary aspect of the invention, an exemplary method for producing a woven/non-woven fabric of natural fiber is provided. The method includes creating a web (e.g., a bundle, pile or mattress etc.) of fibers having a predetermined weight from a combed mass of fibers, spraying the web of fibers with liquid at high pressure, and removing moisture from the sprayed web of fibers.

In a few words, the method includes cleaning the raw fibers, combing the cleaned mass of raw fibers, arranging the dry fabric made from the fibers on a material receiving mechanism, and cutting the fabric to fit a predetermined size and pattern.

According to another exemplary aspect of the invention, the predetermined size and pattern may include one of a disposable personal hygiene product, a napkin, a cleaning cloth, medical gauze, an operating room sheet, sterile swab, disposable towel, handkerchief, make-up napkin, glass/lens cleaner, floor wipe, kitchen drying cloth, a non-allergenic web for sanitary towels, disposable diapers, car cloth, and metal cleaning cloth.

According to another exemplary aspect of the invention, the raw fibers used to produce a woven/non-woven fabric are pure cotton.

According to another exemplary aspect of the invention, the combing of the cleaned mass of fibers includes removing fibers that are less than 10 mm in length and removing dust particles from the fibers.

According to another exemplary aspect of the invention, the cleaning of the raw fibers includes removing grease and treating the fibers with hydrogen peroxide.

According to another exemplary aspect of the invention, the combing of the cleaned mass of fibers includes carding the fibers with carding cylinders.

According to another exemplary aspect of the invention, creating a web of fibers includes applying the fibers on a tape surface.

According to another exemplary aspect of the invention, spraying the web of fibers with liquid includes spraying the web with pure water.

According to another exemplary aspect of the invention, the spraying of the liquid is performed at a pressure between 30-80 bar.

According to another exemplary aspect of the invention, the drying of the web includes using an oven.

According to another exemplary aspect of the invention, the drying of the web includes subjecting the sprayed web to a temperature of 160° C. for a predetermined period of time (e.g., preferably between about 15-20 seconds).

According to another exemplary aspect of the invention, the web of woven/non-woven fabric includes fibers between about 8 millimeters (e.g., mm) to about 18 millimeters in length.

Additionally, in accordance with another exemplary aspect of the invention, a woven/non-woven fabric includes a plurality of waste threads of a natural fiber shaped as a web with fibers in a range of length between 8-18 mm and weighing less than 35 grams per square meter.

According to another exemplary aspect of the invention, the plurality of waste threads used in the woven/non-woven fabric of the invention are a by-product of a spinning process for a conventional type of cloth.

According to another exemplary aspect of the invention, the plurality of waste threads used in the woven/non-woven fabric are pure cotton.

In an additional exemplary aspect of the invention, an apparatus for producing a natural woven/non-woven fabric, is provided and includes a web-maker for creating a web of fibers, a sprayer attached to the web-maker for spraying the web of fibers with liquid at high pressure, and a moisture reducing device for receiving and reducing a moisture content of the sprayed web of fibers to produce the woven/non-woven fabric.

According to another exemplary aspect of the invention, an apparatus also includes a cleaning unit for degreasing the fibers and outputting them to the web-maker, a comber located between the cleaning unit and the web-maker, and the where the cleaning unit degreases the fibers using hydrogen peroxide and water.

According to another exemplary aspect of the invention, the comber includes carding cylinders for isolating fibers with a length between about 8 mm to about 18 mm q.

According to another exemplary aspect of the invention, the apparatus includes a material receiving mechanism attached to the moisture removal mechanism for holding the woven/non-woven fabric, and a cutter for patterning the woven/non-woven fabric.

With the unique and unobvious combination of features of the present invention, an inexpensive woven/non-woven fabric is provided for use in disposable personal hygiene products and which is reusable in household applications. The fabric is bound in such a manner that, even when moistened or immersed in liquid (e.g., soaked), it retains its consistency and can be reused. Further, the fabric is bound without using pollutants and non-biodegradable materials.

One of the main advantages is that the present invention derives from cyclic cultivations (e.g., cotton growing), and therefore, there are neither by-products of oil nor by-products of wood.

The present disclosure relates to subject matter contained in Italian Patent Application No. BS/2002/A/000068, filed on Jul. 31, 2002, which is expressly incorporated herein by reference in its entirety.

### BRIEF DESCRIPTION OF THE DRAWINGS

The foregoing and other purposes, exemplary aspects and advantages will be better understood from the following detailed description of exemplary embodiments of the invention with reference to the drawings, in which:

FIG. 1 shows an exemplary embodiment of a method 100 for producing a woven/non-woven fabric according to the present invention;

FIGS. 2(a) and 2(b) respectively illustrate a top view and a side view of the fabric 200 thus produced; and

FIG. 3 illustrates an apparatus 300 according to the present invention.

### DETAILED DESCRIPTION OF EXEMPLARY EMBODIMENTS OF THE INVENTION

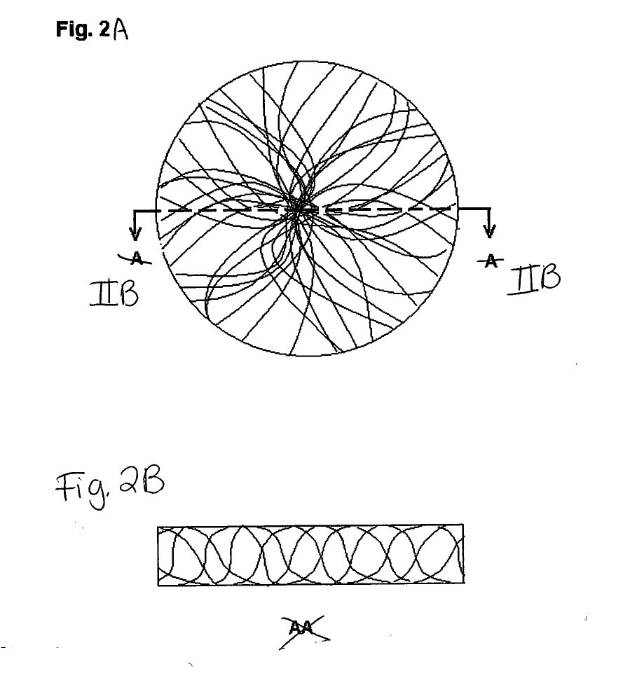

Referring now to the drawings, and more particularly to FIGS. 1-3, there is shown an exemplary embodiment of the method and structure according to the present invention.

### Exemplary Embodiments

Firstly, the present invention employs raw materials in a way heretofore unknown for the production of woven/non-woven fabrics used in various end products. In the present invention, a highly resistant woven/non-woven fabric is produced using a process previously reserved for the production of synthetic fibers of a standard length or of the production of natural fibers with a length greater than 25 mm.

The fabric of the present invention is made of 100% non-allergenic natural fiber (e.g., fiber 210, as shown in FIG. 2). For example, in a non-limiting embodiment, the fibers are pure cotton fibers (e.g., combed noils) having a length between 8 to 18 mm and not thicker than 4.5 micronaire, which are the by-product of a conventional spinning process of cotton fibers. Thus, the present invention uses the by-products of a conventional cotton manufacturing process as its raw material and recycles them into usable fabric. The natural fibers (e.g., fibers of pure cotton) used have a high absorption capacity. Absorption tests show that the fabric can absorb a quantity of water which is 15-16 times heavier than the fabric itself (e.g., 10 g. of dry fabric=160 g. of water absorption capacity). The fabric may also be initially prepared and treated with a process including bleaching and/or exposing to high temperature for drying. Such an exposure to high temperature results in bacteria dying.

As shown in FIG. 1, the method of the invention 100 includes a step 110 of cleaning the fibers with a hydrophilic process. This process includes treating the fibers with a disinfectant or an oxidizing agent (e.g., such as hydrogen peroxide, soap, and/or the like) for a predetermined period of time (e.g., approximately 4 hours in one exemplary embodiment) to degrease and clean the fibers.

In step 120, the treated fibers are processed and separated by a combing process to remove tangles from the mass of fibers, excess dust, and short fibers. The combing also allows laying the fibers in order. For example, a mechanical treatment of the fibers may be performed including combing the fibers with carding cylinders. The carding cylinders are equipped with dust separators for removing dust and short fibers (e.g., preferably fibers shorter than 10 mm) from the natural fibers.

Then, as shown in FIG. 1, a step 130 of creating a web of separated fibers, having a thickness in the range of approximately 1 mm to about 10 mm and a predetermined weight, is applied. The fibers are laid on a conveyor belt in a regular and uniform way. The fibers are laid by using air flows (e.g., air suction or air pressure) to create a web with a predetermined weight (e.g., depending on the application not less than 35 gr/sq m) and thickness (e.g., from about 1 mm to about 10 mm maximum), and a minimum of dust on a perforated conveyor belt. Such air flow, blown at a set speed through the holes of the conveyor belt, lays the fibers in a regular and uniform way.

This step is performed in an environment constantly kept under hygro-thermal control. During the working process, the temperature is approximately 20-22° C. with a relative humidity rate of 65% to avoid electrostatic charges. Each machine is vacuum-operated to avoid dust. The level of dust is monitored in the cleaning steps because the combing process removes all of the dust by proper exhausters. Such a process cannot be electrostatic because electrostatic forces can damage cotton fibers during the working process.

The web laid on the conveyor belt and held in this manner (e.g., by air suction or air pressure) is uniform (because of the air flow process on the perforated conveyor belt) and fragile. This process holds the web together until the spraying step (step 140) that gives consistency and tear resistance.

As shown in FIG. 1, the process of producing the woven/non-woven fabric includes treating the web in step 140 preferably by spraying a jet of liquid (e.g., water or sweetened water to avoid incrustations), employed in small quantities allowed under current standards, thereby sanitizing substances to avoid bacteria. The diameter of the exemplary spray jet nozzles used is about 0.100 to about 0.120 micron. The exemplary temperature of the liquid may be between about 15° C. to about 30° C. The spraying time depends on the speed of travel of the web (e.g., the faster the speed of the web, the higher the water pressure, and preferably within a range of about of 30 bar to about of 80 bar) to give it a predetermined consistency and rigidity.

The following are values according to tests of the exemplary fabric carried out with a dynamometer on the dry fabric:

Tests: lengthwise
Minimum 8.5 N/Cm
Maximum 9.5 N/Cm

Tests: crosswise
Minimum 5.5 N/Cm
Maximum 6.5 N/Cm

According to the characteristics of the web and the desired consistency, a pressure of the jet may be preferably between about 30 to about 80 bar. The liquid (e.g., water in a preferred embodiment) used in the jet is filtered through a cartridge in the end with a series of sand-filters to avoid the presence of any solid particles. The liquid is also decalcified (e.g., preferably, the water is made substantially pure).

In the exemplary method of the present invention, such a pressure binds the fibers 210 in the web 200 together permanently in a horizontal direction (e.g., planar) and vertical direction (e.g., perpendicular to the web plane), as illustrated in FIGS. 2(a) and 2(b) showing a top view and a side view of the web 200, respectively.

Then, in step 150, drying of the sprayed web is performed. Several known drying methods can be applied including oven drying. In one exemplary method, drying can be performed at a temperature of 160° C. for approximately 20 seconds to sterilize the fabric and to further bind the fibers together in the web. There is no important shrinkage percentage of the natural fibers.

After drying, in step 160 the web is placed on a material receiving mechanism (e.g., bobbins).

Finally, as shown in FIG. 1, a step 170 of cutting the web is performed to produce swaths of woven/non-woven fabric of a predetermined size. The fabric cut is made by two blades (e.g., a pair of scissors with one blade and one counter-blade) or, in the alternative, by a pressure blade placed on an hardened-chromium-plated cylinder.

Thus, the present invention uses recycled by-products of natural fibers with no standard length. Preferably, the natural fibers are shorter than the conventional natural fiber length (e.g., 25 mm or more) and preferably have a length between about 8 to about 18 mm and more preferably between about 10 to about 18 mm. Such a length is important since the process is carried out by air. That is, if there is a significant difference in the length of the fibers, then the fibers will be laid on the belt in an irregular way. Such irregularity of the fibers would produce an uneven web.

As shown FIG. 3, besides the unique method and fabric formed by the method, the present invention includes an apparatus 300 for producing the woven/non-woven fabric. The apparatus 300 includes a cleaner 310 for degreasing and cleaning raw fibers, a comber 320 (e.g., carding cylinders), a web-maker 330 including a conveyor belt for holding the fibers deposited by air flows, a sprayer 340 with jets for moistening the web, a moisture removal mechanism 350 for reducing a moisture content in the web, a material receiving mechanism 360 for holding the finished fabric, and a cutter for sizing and patterning the fabric for a predetermined end use.

In operation, as shown in FIGS. 1-3, a step 110 of cleaning raw fibers is performed by a cleaner 310, then the clean fibers enter the comber 320 where a step 120 of combing the fibers is performed. The combed fibers are then introduced to the web-maker 330 which performs a step 130 of creating a web of fibers. Subsequently, step 140 of spraying the web of fibers with liquid is performed in a sprayer 340 followed by step 150 of drying the web in a moisture removal mechanism 350. Once the moisture has been removed by the moisture removal mechanism 350, a step 160 of arranging the dry fabric on a material receiving mechanism 360 is performed. Finally, a step 170 of cutting the woven/non-woven fabric is performed by a cutter 370 which sizes and patterns the fabric depending upon an end use.

Thus, with appropriate mechanical and pneumatic adjustments to the conventional manufacturing plants, the present invention provides for the processing of raw materials previously not used to produce woven/non-woven fabrics.

Additionally, in the present invention, by employing the technology used in the production of woven/non-woven fabrics, including perforating jets of liquid (e.g., water) at high pressure (e.g., used today to process synthetic and artificial fibers) on raw material by-products (e.g., cotton), a preliminary web (e.g., of cotton fibers with a weight of 35-250 gr/sq.m) is subjected to a process that yields a water and tear resistant fabric (e.g., with a weight not less than about 35 gr/sq.m).

The following are values according to tests carried out with a dynamometer on the wet fabric:

Tests: lengthwise
Minimum 5.6 N/Cm
Maximum 7 N/Cm

Tests: crosswise
Minimum 4.8 N/Cm
Maximum 5.3 N/Cm

In addition, a crash test was performed by dropping in free fall a beam having a weight of 130 g onto the fabric.

In the present invention, a fabric is produced which is biodegradable and completely non-toxic. That is, the present invention is a fabric which is made of natural fibers and is only processed with water (e.g., no chemical additives of any kind, including liquids, fibers, vapors, or atomizers are used).

Therefore, by appropriate mechanical and pneumatic adjustments to the conventional manufacturing plants and processes, the present invention provides a woven/non-woven fabric usable in disposable products for personal hygiene and for household applications inexpensively and with minimal waste.

The finished product is a woven/non-woven fabric for use in the production of a wide range of products with high versatility. These may include handkerchiefs, napkins, cloths, glass and lens cleaners, floor wipes, and as drying cloths for wet surfaces. The woven/non-woven fabric of the invention does not leave a residue of fibers, hairs, or marks and can be washed and re-used.

In this manner, a new type of disposable fabric is obtained that can replace the conventional woven/non-woven fabrics having similar physical characteristics, but produced with synthetic and artificial raw materials.

The woven/non-woven fabric is biodegradable and absolutely non-toxic, as it is produced with natural fibers and processed with pure water. That is, the water used in the process does not include any chemical additives (e.g., either liquids, fibers, vapors, or atomizers).

The woven/non-woven fabric may be used in many different applications. For example, the fabric may be used in medical applications as its bacterial charge is less than 20 UFC. Thus, gauzes, sheets for medical and paramedical use, sterile sheets, and disposable towels are some of the possible applications in the medical field.

The fabric may be used in the cosmetic field (e.g., as a moist, refreshing handkerchief or napkin to remove make-up from the skin).

Also, the fabric may be used in personal care products such as in disposable handkerchiefs, cleansing napkins, protective, as a non-allergenic web in sanitary towels and diapers.

Further, the fabric may be used in home settings or by the hospitality industry (e.g., in tablecloths, napkins, towels, disposable sheets, dust cloths, and cloths for glasses and floors). The woven/non-woven fabric, because of its unique and novel process, provides a larger contact surface (e.g., about 60-70%) than that of a conventional fabric. That is, in the conventional fabric, the mechanical process employs just one twisted thread which needs a small base. In contrast, the woven/non-woven fabric of the invention includes many single threads. The woven/non-woven fabric provides a larger contact surface because each thread is in contact with the base and no empty space is left between the fabric and the base.

Additionally, the fabric may be useable in cleaning products (e.g., in cloths for cleaning cars, railway carriages, aircraft, metallic parts, glass, and for general industrial cleaning).

One of the main features of this product is the high absorption capacity. Thus, it can be especially employed by dentists or the health care industry (e.g., sheets for massages, towels and all disposable items).

As described above, the present invention provides an economic, natural fiber woven/non-woven fabric and method for producing the same that can be used in the production of hygiene and household applications which is reusable, tear resistant, and ecological.

While the invention has been described in terms of several exemplary embodiments, those skilled in the art will recognize that the invention can be practiced with modification within the spirit and scope of the appended claims.

Further, it is noted that Applicant's intent is to encompass equivalents of all claim elements, even if amended later during prosecution.

1. A method for processing a woven/non-woven fabric of natural fiber, said method comprising:
creating a web of fibers having a predetermined weight;
spraying the web of fibers with a liquid at a predetermined high pressure; and
removing moisture from the sprayed web of fibers.

2. The method according to claim 1, further comprising:
prior to said creating, cleaning raw fibers; and
combing a mass of raw fibers, and
after said removing moisture, cutting the web of fibers to a predetermined size and pattern.

3. The method according to claim 2, wherein said predetermined size and pattern comprises one of a disposable personal hygiene product, a napkin, a cleaning cloth, medical gauze, sheets for medical and paramedical use, a disposable towel, a handkerchief, a make-up napkin, a glass/lens cleaner, a floor wipe, a kitchen drying cloth, a non-allergenic web for sanitary towels, disposable diapers, a car cloth, and a metal cleaning cloth.

4. The method according to claim 1, wherein said fibers comprise pure cotton.

5. The method according to claim 2, wherein said combing the mass of raw fibers comprises removing fibers less than about 10 mm in length.

6. The method according to claim 2, wherein said cleaning the raw fibers comprises treating the raw fibers with hydrogen peroxide.

7. The method according to claim 2, wherein said combing the mass of raw fibers comprises carding the raw fibers with carding cylinders.

8. The method according to claim 1, wherein said creating a web of fibers comprises applying the fibers on a tape surface.

9. The method according to claim 1, wherein said spraying the web of fibers with the liquid comprises spraying the web of fibers with pure water.

10. The method according to claim 1, wherein said predetermined high pressure comprises a pressure in a range between about 30 bar to about 80 bar.

11. The method according to claim 1, wherein said removing moisture comprises using a drying oven.

12. The method according to claim 1, wherein said removing moisture comprises subjecting the sprayed web to a temperature of approximately 160° C. for a predetermined period of time.

13. The method according to claim 1, wherein the web of fibers comprises fibers in a range between about 8 mm to about 18 mm.

14. A woven/non-woven fabric, comprising:
a plurality of waste threads of a natural fiber forming a web of a predetermined weight,
wherein a consistency and rigidity of the web are provided by a liquid spray at high pressure and subsequent removal of moisture using high temperature.

15. The woven/non-woven fabric as claimed in claim 14, wherein said plurality of waste threads comprises fibers in a range of length between about 8 mm to about 18 mm, and
wherein a weight of said web of waste threads is not less than about 35 grams per square meter.

16. The woven/non-woven fabric as claimed in claim 14, wherein said plurality of waste threads comprise a by-product of a spinning process.

17. The woven/non-woven fabric as claimed in claim 14, wherein said plurality of waste threads comprise pure cotton.

18. An apparatus for producing a natural woven/non-woven fabric, said apparatus comprising:
a web-maker for creating a web of fibers;
a sprayer attached to said web-maker for spraying the web of fibers with liquid at high pressure; and
a moisture reducing device for receiving and reducing a moisture content of a sprayed web of fibers to produce the woven/non-woven fabric.

19. The apparatus of claim 18, further comprising:
a cleaning unit for degreasing the fibers and outputting them to said web-maker; and
a comber located between said cleaning unit and said web-maker,
wherein said cleaning unit degreases the fibers using any of soaps, hydrogen peroxide and water, and
wherein said comber includes carding cylinders for isolating fibers with a length in a range between about 8 mm to about 18 mm.

20. The apparatus of claim 18, further comprising:
a material receiving mechanism attached to said moisture removal mechanism for holding the woven/non-woven fabric; and
a cutter for patterning the woven/non-woven fabric.
